(19) United States
(12) Patent Application Publication
(10) Pub. No.: US 2026/0296979 A1
(43) Pub. Date: Oct. 1, 2026

(54) DIELECTRIC CERAMIC COMPOSITION AND MULTILAYER CERAMIC ELECTRONIC DEVICE

(71) Applicant: TDK CORPORATION, Tokyo (JP)

(72) Inventors: Ryota NAMIKI, Tokyo (JP); Toshihiro IGUCHI, Tokyo (JP); Atsushi WATANABE, Tokyo (JP); Yoshitomo TANAKA, Tokyo (JP)

(73) Assignee: TDK CORPORATION, Tokyo (JP)

(21) Appl. No.: 19/576,463

(22) Filed: Mar. 24, 2026

(30) Foreign Application Priority Data
Mar. 27, 2025 (JP) 2025-054094

(51) Int. Cl. C04B 35/49; C04B 35/468; C04B 35/48; H01G 4/12; H01G 4/30

(52) U.S. Cl. CPC C04B 35/49; C04B 35/4682; C04B 35/48; H01G 4/1209; C04B 2235/3206; C04B 2235/3217; C04B 2235/3236; C04B 2235/3239; C04B 2235/3248; C04B 2235/3249; C04B 2235/3258; C04B 2235/3262; C04B 2235/3418; C04B 2235/768; H01G 4/30

(57) ABSTRACT

A dielectric ceramic composition contains a main component including a perovskite-type compound and also contains a subcomponent. An A-site of the perovskite-type compound includes at least Ca, and a B-site of the perovskite-type compound includes at least Zr. The subcomponent includes Mn as a first subcomponent element. The first subcomponent element is present at both of an A-site and a B-site of the perovskite-type compound.

### TECHNICAL FIELD

The present disclosure relates to a dielectric ceramic composition and a multilayer ceramic electronic device.

### BACKGROUND

Patent Document 1 discloses a reduction-resistant dielectric ceramic composition that contains a main component including Ca and Zr and that further contains a glass component including Mn. However, recent studies have found that such known dielectric ceramic compositions exhibit decreased service life when used in high-temperature environments.

### Patent Document

Patent Document 1: JP Patent Application Laid Open No. 2007-091588

### SUMMARY

An object of the present disclosure is to provide a dielectric ceramic composition and a multilayer ceramic electronic device that have excellent high-temperature load life.

The present inventors have conducted intensive studies on dielectric ceramic compositions containing a main component including Ca and Zr to improve high-temperature load life. As a result, they have found that when Mn is included at a predetermined ratio at both the A-site and the B-site of a perovskite-type compound, the service life under high-temperature environments is improved. Based on this finding, the present disclosure has been completed.

A dielectric ceramic composition according to one embodiment of the present disclosure contains:
a main component including a perovskite-type compound; and
a subcomponent,
wherein an A-site of the perovskite-type compound includes at least Ca,
a B-site of the perovskite-type compound includes at least Zr,
the subcomponent includes Mn as a first subcomponent element, and
the first subcomponent element is present at both the A-site and the B-site of the perovskite-type compound.

The dielectric ceramic composition exhibits improved high-temperature load life while maintaining satisfactory temperature characteristics.

A distribution ratio of the first subcomponent element to the B-site, which is a ratio of the number of atoms of the first subcomponent element present at the B-site to the total number of atoms of the first subcomponent element present at the A-site and the B-site of the perovskite-type compound, is preferably 20 to 80%, more preferably 30 to 70%.

The subcomponent may further include a second subcomponent element including at least one selected from the group consisting of Mg, Al, Si, Li, B, and P.

The subcomponent may further include a third subcomponent element including at least one selected from the group consisting of V, Nb, Ta, and W.

The third subcomponent element is preferably present at least at the B-site of the perovskite-type compound. A distribution ratio of the third subcomponent element to the B-site, which is a ratio of the number of atoms of the third subcomponent element present at the B-site to the total number of atoms of the third subcomponent element present at the A-site and the B-site of the perovskite-type compound is preferably 70% or more, more preferably 80% or more.

Preferably, the A-site of the perovskite-type compound further contains at least Sr, and the B-site of the perovskite-type compound further contains at least Ti.

The main component of the perovskite-type compound can be represented by the following formula: (Ca₁₋ₓSrₓBa_{α})ₘ(Zr_{1-y-z} Ti_{y}Hf_{z})O₃. Preferably, the following conditions are satisfied: 0.9≤m≤1.1, 0≤x≤1, 0.80≤1-y-z≤1.0, and α<1.

Preferably, y is greater than 0 and not more than 0.1.

A multilayer ceramic electronic device according to one embodiment of the present disclosure includes the dielectric ceramic compositions described above.

### BRIEF DESCRIPTION OF THE DRAWINGS

FIG. 1 is a schematic sectional view of a multilayer ceramic capacitor according to an embodiment of the present disclosure.

FIG. 2 is a HAADF image of a dielectric ceramic composition according to an embodiment of the present disclosure.

FIG. 3A shows measurement results obtained by energy-dispersive X-ray spectroscopy of Mn according to an example of the present disclosure.

FIG. 3B shows measurement results obtained by energy-dispersive X-ray spectroscopy of Mn according to another example of the present disclosure.

FIG. 4 is a schematic view for determining a distribution ratio of an element between the A-site and the B-site based on the relationship of X-ray intensity ratios in an example of the present disclosure.

### DETAILED DESCRIPTION

Hereinafter, embodiments of the present disclosure will be described.

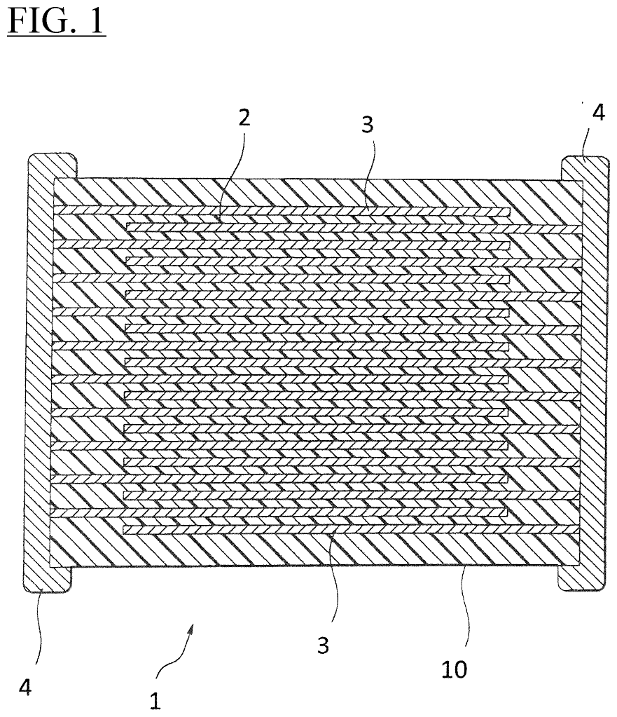

FIG. 1 shows a multilayer ceramic capacitor 1 as an example of an electronic device according to the present embodiment. The multilayer ceramic capacitor 1 includes an element body 10, in which dielectric layers 2 and internal electrode layers 3 are alternately laminated. A pair of external electrodes 4 is formed at both ends of the element body 10. Each of the external electrodes 4 is electrically connected to the internal electrode layers 3 that are alternately arranged inside the element body 10. The shape of the element body 10 is not particularly limited, but is typically a rectangular parallelepiped. In addition, the dimensions of the element body 10 are not particularly limited, and may be appropriately selected depending on the intended application.

The dielectric layers 2 include a dielectric ceramic composition according to the present embodiment, as described later. The thickness per layer (interlayer thickness) of the dielectric layers 2 is not particularly limited, and may be set as appropriate according to desired characteristics and applications. The interlayer thickness is preferably 30 μm or less, more preferably 10 μm or less. The number of laminated dielectric layers 2 is not particularly limited. For example, in the present embodiment, the number is preferably 20 or more.

The internal electrode layers 3 are laminated in such a manner that end surfaces thereof are alternately exposed at two opposing end surfaces of the element body 10.

The internal electrode layers 3 contain a metal-based conductive material. The metal is not particularly limited, and may include known conductive materials such as Pd, Pd-based alloys, Pt, Pt-based alloys, Ni, Ni-based alloys, Cu, and Cu-based alloys. The metal may contain various trace components such as P, S, and Cl, each in an amount of about 0.1 mass % or less. The internal electrode layers 3 may be formed using a commercially available electrode paste. The thickness of the internal electrode layers 3 may be appropriately determined depending on the intended application.

The external electrodes 4 include a conductive material, which is not particularly limited. Examples of the conductive material include known conductive materials such as Ni, Cu, Sn, Ag, Pd, Pt, Au, alloys thereof, and conductive resins. The thickness of the external electrodes 4 may be appropriately determined depending on the intended application.

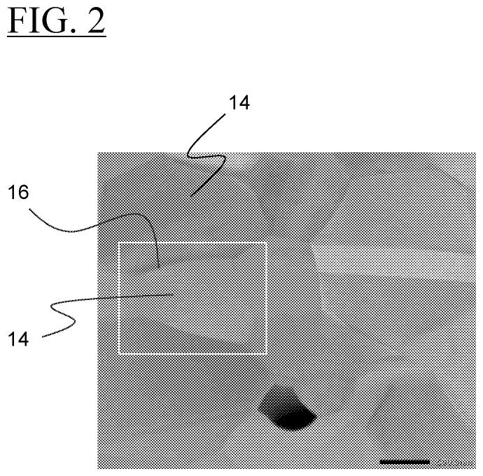

The method for observing the structure of the dielectric ceramic composition is not particularly limited. For example, a cross section of the dielectric ceramic composition may be observed using a backscattered electron image or a HAADF image. The backscattered electron image may be obtained using, for example, a scanning electron microscope (SEM). The HAADF image may be obtained using, for example, a scanning transmission electron microscope (STEM). A HAADF image of a cross section of a dielectric ceramic composition is shown in FIG. 2. Hereinafter, a HAADF image that is obtained using STEM may be simply referred to as a STEM image.

As shown in FIG. 2, the dielectric ceramic composition according to the present embodiment includes main phase grains 14 and grain boundaries 16 present between the main phase grains 14. In backscattered electron images and HAADF images, the main phase grains 14 tend to appear as bright regions compared with grain boundaries 16. This is because the main phase grains 14 tend to be denser than the grain boundaries 16. Thus, the grain boundaries 16, which typically have a lower density than the main phase grains 14, tend to appear as dark regions.

The field of view to be imaged is not particularly limited. For example, the field of view may have dimensions of about 1 to 10 μm on each side and an area of about 1 to 100 μm². The dimensions of the field of view may be appropriately selected depending on the intended purposes.

The main phase grain 14 contains a perovskite-type compound as a main component. The perovskite-type compound has a perovskite-type crystal structure represented by the general formula ABO₃, in which A represents at least one A-site element and B represents at least one B-site element.

The perovskite-type compound contains, as A-site elements, at least Ca, preferably Ca and Sr, and contains, as B-site elements, at least Zr, preferably Zr and Ti. In addition, Ba may be further included as an A-site element, and Hf may be further included as a B-site element.

When Ca is not included as an A-site element, both temperature characteristics and high-temperature load life tend to deteriorate. When Zr is not included as a B-site element, both temperature characteristics and high-temperature load life tend to deteriorate.

The content of Ca per 100 parts by mol of A-site elements may be 10 parts by mol or more and 100 parts by mol or less, 30 parts by mol or more and 100 parts by mol or less, 30 parts by mol or more and 90 parts by mol or less, or 50 parts by mol or more and 80 parts by mol or less. The content of Sr per 100 parts by mol of A-site elements may be 0 parts by mol or more and 50 parts by mol or less, 10 parts by mol or more and 50 parts by mol or less, or 20 parts by mol or more and 45 parts by mol or less. The content of Ba per 100 parts by mol of A-site elements may be 0 parts by mol or more and 25 parts by mol or less, 0 parts by mol or more and 20 parts by mol or less, or 0 parts by mol or more and 5.0 parts by mol or less.

The content of Zr per 100 parts by mol of B-site elements may be 90 parts by mol or more and 100 parts by mol or less, 90 parts by mol or more and 99 parts by mol or less, or 94 parts by mol or more and 98 parts by mol or less. The content of Ti per 100 parts by mol of B-site elements may be 0 parts by mol or more and 10 parts by mol or less, 0 parts by mol or more and less than 7.0 parts by mol, 0.5 parts by mol or more and less than 7.0 parts by mol, or 2.0 parts by mol or more and 6.0 parts by mol or less. The content of Hf per 100 parts by mol of B-site elements may be 0 parts by mol or more and 2.0 parts by mol or less.

The perovskite-type compound of the present embodiment may also be represented by the following formula: (Ca₁₋ₓSrₓBa_{α})ₘ(Zr_{1-y-z} Ti_{y}Hf_{z})O₃, in which the following conditions are satisfied: 0.9≤m≤1.1, 0≤x≤1, 0.80≤1-y-z≤1.0, and α<1.

The dielectric ceramic composition according to the present embodiment contains at least Mn as a first subcomponent element Z1, in addition to the perovskite-type compound described above.

In the dielectric ceramic composition according to the present embodiment, the total content of Z1 with respect to the total content of the B-site elements, namely, the total content of Zr, Ti, and Hf (100 parts by mol), is not particularly limited and may be 0.5 parts by mol or more and 8.0 parts by mol or less. When Mn is not included as the first subcomponent element Z1, both temperature characteristics and high-temperature load life tend to deteriorate.

In the dielectric ceramic composition according to the present embodiment, a distribution ratio of the first subcomponent element Z1 to the B-site is preferably 20 to 80%, more preferably 30 to 70%. When the distribution ratio of the first subcomponent element Z1 is within the above-described range, high-temperature load life can be improved while satisfactory temperature characteristics are maintained.

The distribution ratio of the first subcomponent element Z1 to the B-site refers to the ratio of number of atoms of the first subcomponent element Z1 located at the B-site relative to the total number of atoms of the first subcomponent element Z1 located at the A-site and the B-site of the perovskite-type compound. That is, a distribution ratio of the first subcomponent element Z1 to the B-site of 100% means that all atoms of the first subcomponent element Z1 in the perovskite-type compound are located at the B-site. The distribution ratio to the B-site can be determined by ALCHEMI analysis, which will be described later.

Although the mechanism by which high-temperature load life is improved is not fully understood, it is presumed, for example, as follows. When the first subcomponent element Z1 is incorporated into the A-site or the B-site of the perovskite-type compound, an impurity level is formed between the valence band and the conduction band. The coexistence of elements having different valence states in the impurity level may cause hopping conduction. The impurity level resulting from substitution at the A-site has an energy level different from that of the impurity level resulting from substitution at the B-site. Accordingly, it is presumed that, by appropriately controlling the distribution ratio to the B-site, hopping conduction is suppressed and high-temperature load life is extended.

The distribution ratio of the first subcomponent element Z1 to the B-site can be determined by ALCHEMI analysis described below. In ALCHEMI analysis using TEM, an incident electron beam is controlled so that it is localized at a specific lattice plane within a crystal. Then, in Bragg reflection from the specific lattice plane, the incident electron beam is sequentially tilted to both the positive and negative sides of the Bragg condition. Differences in characteristic X-ray intensity are then analyzed to identify the site where the subcomponent element is present.

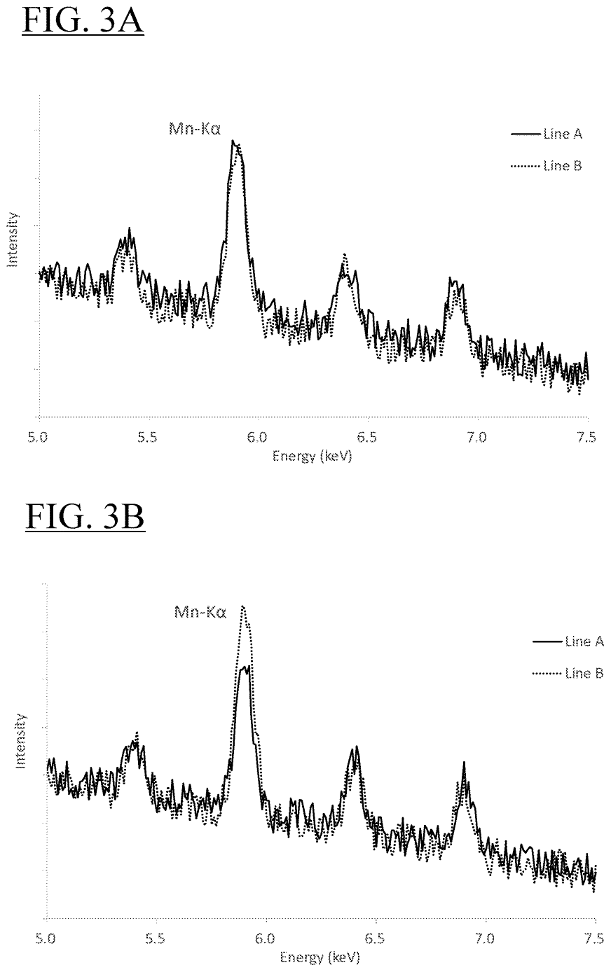

FIG. 3A shows an EDS spectrum of Mn in one example. Here, the A-line corresponds to a spectrum derived from atoms located at the A-site, whereas the B-line corresponds to a spectrum derived from atoms located at the B-site.

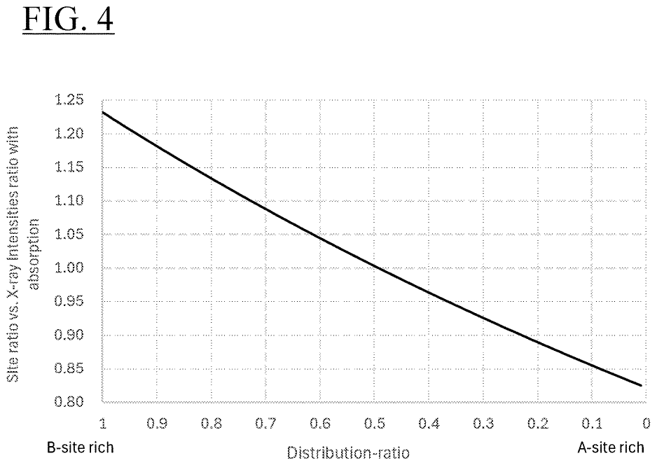

The distribution ratio to the B-site is determined based on the intensity ratio of the respective spectra, as shown in FIG. 4. The distribution ratio to the B-site can be determined as follows. For example, the distribution ratio to the B-site is obtained at three or more different points within a main-phase grain 14, including a point near the centroid of the grain, a point near a grain boundary, and a point other than these portions. Here, the main-phase grain 14 can be arbitrarily selected. The average value thereof is then used as a representative value.

In the present embodiment, the main phase grain 14 shown in FIG. 2 may be a grain having a core-shell structure or a grain that is a complete solid solution. When the main phase grain 14 has a core-shell structure, the distribution ratio to the B-site may be the same or may differ between the core portion and the shell portion. The average value of the distribution ratio to the B-site can be determined by measurement as described above, regardless of whether the grain has a core-shell structure or is a complete solid solution.

The dielectric ceramic composition according to the present embodiment may further contain, in addition to the perovskite-type compound and Z1 described above, at least one selected from the group consisting of Mg, Al, Si, Li, B, and P, or at least one selected from the group consisting of Mg, Si, and Al, as a second subcomponent element Z2. Alternatively, the dielectric ceramic composition according to the present embodiment may contain Si and Al as the second subcomponent element Z2.

In the dielectric ceramic composition according to the present embodiment, the total content of Z2 with respect to the total content of the B-site elements, namely, Zr, Ti, and Hf, is not particularly limited, and may be 0.5 parts by mol or more and 7.0 parts by mol or less. At least a part of Z2 is also expected to function as a sintering aid.

Furthermore, the dielectric ceramic composition according to the present embodiment may contain at least one selected from the group consisting of V, Nb, Ta, and W, as a third subcomponent element Z3. In the dielectric ceramic composition according to the present embodiment, a distribution ratio of the third subcomponent element Z3 to the B-site may be 1% or more, 50% or more, 70% or more, or 80% or more.

In the dielectric ceramic composition according to the present embodiment, the first subcomponent element Z1 and/or the third subcomponent element Z3 may be uniformly dissolved in solid solution throughout the main phase grains 14, or may be present in a large amount in a region near the boundary between the main phase grain 14 and the grain boundary 16.

An example of a method for manufacturing the multilayer ceramic capacitor 1 shown in FIG. 1 is described below.

First, a manufacturing process of the element body 10 is described. In the manufacturing process of the element body 10, a dielectric paste that becomes the dielectric layers 2 after firing and an internal electrode paste that becomes the internal electrode layers 3 after firing are prepared.

The dielectric paste is obtained by kneading together a dielectric powder, a binder, and a solvent (organic solvent or water). The method for manufacturing the dielectric powder is not particularly limited, and may include the following method, for example.

First, a first dispersion and a second dispersion are prepared as raw materials for a main component of the dielectric powder.

The first dispersion is obtained by preparing oxide powders of the A-site elements (Sr, Ca, and Ba) constituting the main component of the perovskite-type compound and dispersing the oxide powders in a solvent (for example, purified water). The second dispersion is obtained by preparing oxide powders of the B-site elements (Zr and Ti) of the perovskite-type compound and dispersing the oxide powders in a solvent.

Oxide powders of the subcomponent elements (the first subcomponent element Z1, the second subcomponent element Z2, and the third subcomponent element Z3) are prepared and dispersed in a solvent to obtain a dispersion of the subcomponents. The dispersion of the subcomponents may be prepared by mixing oxide powders of all the subcomponent elements, or dispersions may be prepared individually for each of the subcomponent elements. The subcomponent elements may be added in an appropriately selected amount; for example, it may be 1 part by weight or more and 5 parts by weight or less per 100 parts by weight of the perovskite-type compound.

Instead of oxide powders of the respective elements, compound powders that become oxides of the respective elements upon sintering may be used. For example, carbonate powders or chloride powders of the respective elements may be used. Alternatively, powders of composite precursor compounds containing the respective elements may be used.

The dispersion containing the first subcomponent element is added to each of the first dispersion and the second dispersion. The obtained mixtures are mixed, dried, and heat-treated to obtain an A-site raw material powder and a B-site raw material powder. At this time, the distribution ratio of the first subcomponent element Z1 to the B-site can be increased (or decreased) by adding a larger amount (or a smaller amount) of the dispersion containing the first subcomponent element to the second dispersion than to the first dispersion.

The distribution ratio of the third subcomponent element Z3 (V, Nb, Ta, and W) to the B-site can also be adjusted in the same manner as that for the first subcomponent element Z1.

The holding temperature in the heat treatment for preparing the A-site raw material powder and the B-site raw material powder is not particularly limited. For example, the holding temperature may be 800° C. or higher and 1300° C. or lower. The holding time is not particularly limited. For example, the holding time may be 0.5 hours or longer and 5 hours or shorter.

The A-site raw material powder and the B-site raw material powder thus obtained are mixed to obtain the dielectric powder.

Thereafter, the obtained dielectric powder, a binder, and a solvent (organic solvent or water) are kneaded together to prepare a dielectric paste. The types of the binder and the solvent are not particularly limited. An organic vehicle obtained by mixing a binder and an organic solvent may be used instead of the binder and the solvent. If necessary, the dielectric paste may contain additives, such as plasticizers and dispersants.

The internal electrode paste is obtained by kneading together a raw material for the above-described conductive material, a binder, and a solvent (organic solvent or water). The types of the binder and the solvent are not particularly limited. If necessary, the internal electrode paste may contain additives, such as sintering inhibitors and plasticizers.

The prepared pastes are used to form green sheets and internal electrode patterns, which are then laminated together to obtain a green chip.

The resultant green chip may be subject to a binder removal treatment as necessary. The binder removal treatment may be performed under known conditions. For example, the holding temperature may be 180° C. or higher and 400° C. or lower, and the holding time may be 0.5 hours or longer and 24 hours or shorter. In addition, the atmosphere during the binder removal treatment is not particularly limited. Under a reducing atmosphere, the holding temperature may be 1100° C. or lower.

After the binder removal treatment, the green chip is fired to obtain the element body 10. In the present embodiment, the firing atmosphere may be a reducing atmosphere with an oxygen partial pressure of 2.0×10⁻¹³ atm or higher and 1.0×10⁻⁷ atm or lower. Other firing conditions may be known conditions. For example, the holding temperature may be 1200° C. or higher and 1400° C. or lower, and the holding time may be 0.5 hours or longer and 8 hours or shorter.

After firing, an annealing treatment may be performed as necessary. The conditions for the annealing treatment are not particularly limited. For example, the holding temperature may be 500° C. or higher and 1150° C. or lower, and the holding time may be 0.5 hours or longer and 20 hours or shorter. The oxygen partial pressure in the annealing atmosphere may be 1.0×10⁻⁹ atm or higher and 3.0×10⁻⁵ atm or lower.

In the element body 10 thus obtained, the dielectric layers 2 are constituted by the dielectric ceramic composition described above. The end surfaces of the element body 10 are polished as necessary. Then, an external electrode paste is applied to the end surfaces and is baked to form the external electrodes 4. Thereafter, if necessary, a coating layer is formed on the surfaces of the external electrodes 4 by plating or the like. The method for preparing the external electrode paste is not particularly limited and may be the same as or similar to that for the internal electrode paste.

Thus, the multilayer ceramic capacitor 1 according to the present embodiment is manufactured.

Although embodiments of the present disclosure have been described above, the present disclosure is not limited thereto and can be variously modified without departing from the gist of the present disclosure.

For example, oxide powders of the A-site elements (Sr, Ca, and Ba) and the B-site elements (Zr, Ti, and Hf) of the perovskite-type compound, powders of a divalent manganese compound and a trivalent manganese compound serving as the first subcomponent element Z1, and raw material powders of other subcomponents may be used. These powders may be dispersed in a solvent (for example, purified water), dried, and then heat-treated to prepare a dielectric powder. At this time, the ratio of the powders of a divalent manganese compound and a trivalent manganese compound is adjusted to control the distribution ratio of the first subcomponent element Z1 between the A-site and the B-site.

The method for obtaining a trivalent manganese compound is not particularly limited. For example, a commercially available product may be used. Alternatively, Mn₂O₃ serving as a trivalent manganese compound may be prepared by firing a manganese compound, such as MnO₂, at 800° C. or lower in an oxidizing atmosphere, such as an air atmosphere.

The method for obtaining a divalent manganese compound is also not particularly limited. For example, a commercially available product may be used. Alternatively, MnO serving as a divalent manganese compound may be prepared by firing a manganese compound, such as MnO₂, in a reducing atmosphere. The reducing atmosphere may be, for example, an N₂—H₂ mixed gas atmosphere or a humidified N₂ gas atmosphere. The oxygen partial pressure in the reducing atmosphere may be 10⁻¹⁸ atm or higher and 10⁻¹¹ atm or lower.

### EXAMPLES

Hereinafter, the present disclosure will be described in further detail with reference to the following Examples. However, the present disclosure is not limited to these Examples.

### Experimental Example 1

### (Sample No. 1)

For Sample No. 1 of Experimental Example 1, the multilayer ceramic capacitor 1 shown in FIG. 1 was manufactured by the following procedure.

First, a dielectric paste for forming the dielectric layers 2 was prepared.

Raw material powders of Ca oxide, Sr oxide, and Ba oxide were weighed so as to obtain the perovskite-type compound shown in Table 1. These powders were dispersed in water to obtain a first dispersion. In addition, raw material powders of Zr oxide and Ti oxide were prepared and weighed, and they were dispersed in water to obtain a second dispersion. The raw material powder of each oxide may include not only an oxide powder but also a powder of compound that becomes an oxide upon heat treatment.

A raw material powder of MnCO₃, which was used instead of a raw material powder of Mn oxide, was weighed and dispersed in water to obtain a dispersion of the first subcomponent element Z1. Specifically, for Sample No. 1, the raw material powder was weighed such that, when the total number of moles of the B-site elements (the total number of moles of Zr, Ti, and Hf) constituting the main component of the perovskite structure was assumed to be 100 parts by mol, the amount of the first subcomponent element Z1 was 2.5 parts by mol.

Al₂O₃ powder in an amount of 25.0 wt % and SiO₂ powder in an amount of 75.0 wt % were weighed and dispersed in water to obtain a dispersion of the second subcomponent element Z2. At this time, the raw material powder containing the second subcomponent element Z2 (Mg, Al, and Si) was weighed such that the total content of the second subcomponent element Z2 was 2.5 parts by mol per 100 parts by mol of the B-site elements (the total number of moles of Zr, Ti, and Hf).

Half of the dispersion of the first subcomponent element Z1 and half of the dispersion of the second subcomponent element Z2 were added to the first dispersion. These dispersions were mixed, dried, and then heat-treated (holding temperature: 400° C., holding time: 2 hours) to obtain the A-site raw material powder.

The rest of the dispersion of the first subcomponent element Z1 and the rest of the dispersion of the second subcomponent element Z2 were added to the second dispersion. These dispersions were mixed, dried, and then heat-treated (holding temperature: 400° C., holding time: 2 hours) to obtain the B-site raw material powder.

The A-site raw material powder and the B-site raw material powder were mixed to obtain the dielectric powder.

The dielectric powder and an organic vehicle were kneaded together to prepare the dielectric paste. Specifically, 10 parts by mass of polyvinyl butyral resin, 5 parts by mass of dioctyl phthalate (DOP) as a plasticizer, and 100 parts by mass of alcohol as a solvent were added to 100 parts by mass of the dielectric powder. They were mixed into a paste using a ball mill to obtain a dielectric paste.

At the same time as, or before or after, preparation of the dielectric paste, an internal electrode paste was also prepared. First, Ni powder, terpineol, ethyl cellulose, and benzotriazole were prepared in a mass ratio of 44.6:52.0:3.0:0.4. They were then kneaded into a paste using a triple-roll mill to obtain an internal electrode paste.

Then, using the dielectric paste and the internal electrode paste, a green chip was manufactured by a sheet forming method. Thereafter, the green chip was subject to a binder removal treatment, a firing treatment, and an annealing treatment. As a result, an element body 10 having a rectangular parallelepiped shape with dimensions of 3.2 mm×1.6 mm×0.7 mm was obtained. These dimensions indicate that the element body 10 having the structure shown in FIG. 1 had a lateral dimension of 3.2 mm and a vertical dimension (laminated direction) of 0.7 mm.

In the firing treatment, the holding temperature was set to 1200 to 1300° C., the holding time was set to 2.0 hours, and the firing atmosphere was a reducing atmosphere with an oxygen partial pressure of 2.0×10⁻¹³ atm or higher and 1.0×10⁻⁷ atm or lower. In the obtained element body 10, the number and the average thickness of laminated dielectric layers 2 each interposed between the internal electrode layers 3 were 10 and 5.0 μm, respectively, and the average thickness of the internal electrode layers 3 was 1.2 μm.

Regarding the holding temperature during firing, preliminary tests were conducted on each sample at six holding temperatures: 1200° C., 1220° C., 1240° C., 1260° C., 1280° C., and 1300° C. Among the holding temperatures at which the element body 10 was densified, the lowest holding temperature was adopted. Whether the element body 10 was densified was determined by observing a cross section of the element body 10 using SEM. Specifically, it was determined whether, in a field of view of at least 450 μm² in a cross section of the element body 10, an area of void regions was 2% or less relative to an area occupied by the dielectric layers 2 within the field of view. When the element body 10 was not densified at any of the holding temperatures, the holding temperature at which the element body 10 exhibited the highest degree of densification was adopted. Accordingly, the holding temperature was set to 1300° C.

Next, a baked electrode layer containing Cu, a Ni plating layer, and a Sn plating layer were formed in this order on the outer surfaces of the element body 10, thereby forming external electrodes 4. As a result, the multilayer ceramic capacitor 1 was obtained.

### (Composition of Dielectric Ceramic Composition)

The composition of the dielectric ceramic composition was analyzed by ICP optical emission spectroscopy using samples obtained from the dielectric layer 2. It was confirmed that the prepared composition was substantially the same as the dielectric ceramic composition with respect to the contents of the A-site elements, the B-site elements, and the elements of the subcomponents.

### (Distribution Ratio Measurement by ALCHEMI Analysis)

A thin specimen was obtained from the dielectric layer located near the center of the element body by microsampling using a focused ion beam (FIB) apparatus (NX5000). The thin specimen was subjected to ALCHEMI analysis by TEM-EDS using a JEM-2100F, which is manufactured by JEOL Ltd. Here, EDS spectra were acquired for about 200 seconds under each diffraction condition at an accelerating voltage of 100 kV, with a CL aperture of 40 m, in NBD mode. In this measurement, Ca, Sr, and Ba constituting the main component were confirmed to be located only at the A-site, and Zr and Ti, also constituting the main component, were confirmed to be located only at the B-site.

FIG. 3A shows an EDS spectrum of Mn in the dielectric layer of Sample No. 1. The intensity ratio for the distribution ratio of Mn to each of the A-site and the B-site was calculated numerically, and the distribution ratios were determined by comparing the calculated intensity ratios with the measured intensity ratios. Results are shown in Table 1.

### (Temperature Characteristics)

A temperature coefficient of capacitance τC (unit: ppm/° C.) was measured to evaluate the temperature characteristics of the multilayer ceramic capacitor 1. Specifically, capacitance was measured at 25° C. and 125° C. by applying a signal having a frequency of 1 kHz and an input signal level (measurement voltage) of 1 Vrms to the multilayer ceramic capacitor. Then, τC was calculated using the following formula based on the capacitance C(25) at 25° C. and the capacitance C(125) at 125° C.

$$τ C = \{ ( C ( 125 ) - C ( 25 ) ) / C ( 25 ) \} \times \{ 1 / ( 125 - ( 25 ) ) \}$$

The value τC was measured for ten multilayer ceramic capacitors 1, and the obtained values were averaged. When the average τC was −30 ppm/° C. or more and +30 ppm/° C. or less, the sample was evaluated as good.

### (MTTF Measurement for Reliability Evaluation)

The high-temperature load life of the multilayer ceramic capacitor 1 was evaluated. Specifically, the service life was measured while maintaining application of a DC voltage of 800 V (160 V/μm) to the sample at 200° C. In the Examples, the service life was defined as the shorter of the time from the start of voltage application until the insulation resistance decreased by one order of magnitude and the time from the start of voltage application until the sample failed. In the Examples, this measurement was performed on 20 multilayer ceramic capacitors 1, and the mean time to failure (MTTF) was determined from the service life of each multilayer ceramic capacitor 1. A longer MTTF is preferable. An MTTF of 2.00×10² hours or more and less than 1.00×10³ hours is particularly preferable, and an MTTF of 1.00×10³ hours or more is more preferable. Results are shown in Table 1. In Table 1, the expression “βE+γ” denotes β×10^{γ}.

### (Sample Nos. 2 to 10)

The capacitor samples of Sample Nos. 2 to 10 were prepared in the same manner as Sample No. 1, except that the compositions of the main component and/or the subcomponents of the dielectric layer 2 were changed to those shown in Table 1. These samples were evaluated in the same manner as Sample No. 1. Results are shown in Table 1.

### (Sample No. 11)

Raw material powders of Ca oxide, Sr oxide, Ba oxide, Zr oxide, and Ti oxide, Al₂O₃ powder, SiO₂ powder, and MnCO₃ powder were dispersed in purified water, dried, and then heat-treated to obtain a dielectric powder. In the heat treatment, the holding temperature was set to 400° C., and the holding time was set to 2.0 hours. The capacitor sample of Sample No. 11 was prepared in the same manner as Sample No. 1 except for the above-described modification. The sample was evaluated in the same manner as Sample No. 1. Results are shown in Table 1.

TABLE 1

| | | | | | First Subcomponent | |
|---|---|---|---|---|---|---|
| Example/ | | | Electrode | | Distribution | Distribution |
| Comparative | Sample | | Main | First | Ratio to the | Ratio to the |
| Example | No. | Dielectric Main Composition | Composition | Subcomponent | A-site [%] | B-site [%] |
| Example | 1 | (Ca_{0.7}Sr_{0.3})(Zr_{0.97}Ti_{0.03})O₃ | Ni | Mn | 49.6 | 50.4 |
| Example | 2 | (Ca_{0.7}Sr_{0.3})(Zr_{0.93}Ti_{0.07})O₃ | Ni | Mn | 50.0 | 50.0 |
| Example | 3 | (Ca_{0.7}Sr_{0.3})(Zr_{0.91}Ti_{0.09})O₃ | Ni | Mn | 49.6 | 50.4 |
| Example | 4 | (Ca_{0.7}Sr_{0.3})(Zr_{0.75}Ti_{0.25})O₃ | Ni | Mn | 50.9 | 49.1 |
| Example | 5 | (Ca_{0.10}Sr_{0.65}Ba_{0.25})(Zr_{0.94}Ti_{0.06})O₃ | Ni | Mn | 51.0 | 49.0 |
| Example | 6 | CaZrO₃ | Ni | Mn | 49.4 | 50.6 |
| Example | 7 | (Ca_{0.7}Sr_{0.3})(Zr_{0.97}Ti_{0.03})O₃ | Ni | Mn | 50.7 | 49.3 |
| Example | 8 | (Ca_{0.7}Sr_{0.3})(Zr_{0.97}Ti_{0.03})O₃ | Ni | Mn | 49.4 | 50.6 |
| Comparative | 9 | BaTiO₃ | Ni | Mn | 49.3 | 50.7 |
| Example | | | | | | |
| Comparative | 10 | (Ca_{0.7}Sr_{0.3})(Zr_{0.97}Ti_{0.03})O₃ | Ni | — | — | — |
| Example | | | | | | |
| Example | 11 | (Ca_{0.7}Sr_{0.3})(Zr_{0.97}Ti_{0.03})O₃ | Ni | Mn | 89.0 | 11.0 |

| | | | | Third Subcomponent | | |
|---|---|---|---|---|---|---|
| Example/ | | | | Distribution | Distribution | |
| Comparative | Sample | Second | Third | Ratio to the | Ratio to the | MTTF |
| Example | No. | Subcomponent | Subcomponent | A-site [%] | B-site [%] | (h) |
| Example | 1 | Al, Si | Not Added | — | — | 1.42.E+03 |
| Example | 2 | Al, Si | Not Added | — | — | 1.31.E+03 |
| Example | 3 | Al, Si | Not Added | — | — | 1.24.E+03 |
| Example | 4 | Al, Si | Not Added | — | — | 1.20.E+03 |
| Example | 5 | Al, Si | Not Added | — | — | 1.00.E+03 |
| Example | 6 | Al, Si | Not Added | — | — | 1.04.E+03 |
| Example | 7 | Mg, Al, Si | Not Added | — | — | 1.12.E+03 |
| Example | 8 | Si | Not Added | — | — | 1.38.E+03 |
| Comparative | 9 | Al, Si | Not Added | — | — | 2.50.E+01 |
| Example | | | | | | |
| Comparative | 10 | Al, Si | Not Added | — | — | 1.02.E+02 |
| Example | | | | | | |
| Example | 11 | Al, Si | Not Added | — | — | 1.26.E+02 |

As shown in Table 1, the service life in the high-temperature environment can be extended when the main component composed of a perovskite-type compound contains Ca as the A-site element and Zr as the B-site element, and Mn is contained as the first subcomponent element and is present at both the A-site and the B-site. Each of the samples of the Examples exhibited good temperature characteristics TC.

On the other hand, Sample No. 10, which did not contain Mn, exhibited a short service life in the high-temperature environment. In Sample No. 9, in which the dielectric layer was composed of barium titanate, the effect for extending service life was not obtained, and the temperature characteristics were also insufficient.

### Experimental Example 2 (Sample Nos. 12 to 19)

The capacitor samples of Sample Nos. 12 to 19 were prepared in the same manner as Sample No. 1, except for the following modification. The amount of the dispersion of the first subcomponent element Z1 to be added to the first dispersion was adjusted, whereby the distribution ratios of the first subcomponent element to the A-site and the B-site were changed to those shown in Table 2. These samples were evaluated in the same manner as Sample No. 1. Results are shown in Table 2. FIG. 3B shows an EDS spectrum of Mn used for ALCHEMI analysis of the dielectric layer of Sample No. 12.

TABLE 2

| | | | | | First Subcomponent | |
|---|---|---|---|---|---|---|
| Example/ | | | Electrode | | Distribution | Distribution |
| Comparative | Sample | | Main | First | Ratio to the | Ratio to the |
| Example | No. | Dielectric Main Composition | Composition | Subcomponent | A-site [%] | B-site [%] |
| Example | 12 | (Ca_{0.7}Sr_{0.3})(Zr_{0.97}Ti_{0.03})O₃ | Ni | Mn | 10.1 | 89.9 |
| Example | 14 | (Ca_{0.7}Sr_{0.3})(Zr_{0.97}Ti_{0.03})O₃ | Ni | Mn | 20.5 | 79.5 |
| Example | 15 | (Ca_{0.7}Sr_{0.3})(Zr_{0.97}Ti_{0.03})O₃ | Ni | Mn | 30.6 | 69.4 |
| Example | 16 | (Ca_{0.7}Sr_{0.3})(Zr_{0.97}Ti_{0.03})O₃ | Ni | Mn | 40.1 | 59.9 |
| Example | 1 | (Ca_{0.7}Sr_{0.3})(Zr_{0.97}Ti_{0.03})O₃ | Ni | Mn | 49.6 | 50.4 |
| Example | 17 | (Ca_{0.7}Sr_{0.3})(Zr_{0.97}Ti_{0.03})O₃ | Ni | Mn | 60.3 | 39.7 |
| Example | 18 | (Ca_{0.7}Sr_{0.3})(Zr_{0.97}Ti_{0.03})O₃ | Ni | Mn | 70.8 | 29.2 |
| Example | 19 | (Ca_{0.7}Sr_{0.3})(Zr_{0.97}Ti_{0.03})O₃ | Ni | Mn | 80.0 | 20.0 |
| Example | 13 | (Ca_{0.7}Sr_{0.3})(Zr_{0.97}Ti_{0.03})O₃ | Ni | Mn | 85.2 | 14.8 |

| | | | | Third Subcomponent | | |
|---|---|---|---|---|---|---|
| Example/ | | | | Distribution | Distribution | |
| Comparative | Sample | Second | Third | Ratio to the | Ratio to the | MTTF |
| Example | No. | Subcomponent | Subcomponent | A-site [%] | B-site [%] | (h) |
| Example | 12 | Al, Si | Not Added | — | — | 1.32.E+02 |
| Example | 14 | Al, Si | Not Added | — | — | 2.54.E+02 |
| Example | 15 | Al, Si | Not Added | — | — | 1.35.E+03 |
| Example | 16 | Al, Si | Not Added | — | — | 1.16.E+03 |
| Example | 1 | Al, Si | Not Added | — | — | 1.42.E+03 |
| Example | 17 | Al, Si | Not Added | — | — | 1.22.E+03 |
| Example | 18 | Al, Si | Not Added | — | — | 1.33.E+03 |
| Example | 19 | Al, Si | Not Added | — | — | 4.17.E+02 |
| Example | 13 | Al, Si | Not Added | — | — | 1.34.E+02 |

As shown in Table 2, the service life in the high-temperature environment is extended when the main component composed of a perovskite-type compound contains Ca as the A-site element and Zr as the B-site element, and Mn is contained as the first subcomponent element. The distribution ratio of the first subcomponent element to the B-site is preferably 20 to 80%, more preferably 30 to 70%. In addition, each of the samples of the Examples exhibited good temperature characteristics.

### Experimental Example 3 (Sample Nos. 20 to 29)

The capacitor samples of Sample Nos. 20 to 29 were prepared in the same manner as Sample No. 1, except for the following modification. A dispersion of the third subcomponent element Z3 was prepared, and one-half thereof was added to each of the first dispersion and the second dispersion so that the elements shown in Table 3 were contained as the third subcomponent element. These samples were evaluated in the same manner as Sample No. 1. The total content of the third subcomponent element Z3 was set to 0.3 parts by mol per 100 parts by mol of Zr, Ti, and Hf in total. For the third subcomponent element added, the distribution ratios to the A-site and the B-site were determined by ALCHEMI analysis in the same manner as for the first subcomponent element. Results are shown in Table 3.

TABLE 3

| | | | | | First Subcomponent | |
|---|---|---|---|---|---|---|
| Example/ | | | Electrode | | Distribution | Distribution |
| Comparative | Sample | | Main | First | Ratio to the | Ratio to the |
| Example | No. | Dielectric Main Composition | Composition | Subcomponent | A-site [%] | B-site [%] |
| Example | 1 | (Ca_{0.7}Sr_{0.3})(Zr_{0.97}Ti_{0.03})O₃ | Ni | Mn | 49.6 | 50.4 |
| Example | 20 | (Ca_{0.7}Sr_{0.3})(Zr_{0.97}Ti_{0.03})O₃ | Ni | Mn | 49.2 | 50.8 |
| Example | 21 | (Ca_{0.7}Sr_{0.3})(Zr_{0.97}Ti_{0.03})O₃ | Ni | Mn | 49.5 | 50.5 |
| Example | 22 | (Ca_{0.7}Sr_{0.3})(Zr_{0.97}Ti_{0.03})O₃ | Ni | Mn | 50.6 | 49.4 |
| Example | 23 | (Ca_{0.7}Sr_{0.3})(Zr_{0.97}Ti_{0.03})O₃ | Ni | Mn | 50.9 | 49.1 |
| Example | 24 | (Ca_{0.7}Sr_{0.3})(Zr_{0.97}Ti_{0.03})O₃ | Ni | Mn | 50.1 | 49.9 |
| Example | 25 | (Ca_{0.7}Sr_{0.3})(Zr_{0.97}Ti_{0.03})O₃ | Ni | Mn | 49.5 | 50.5 |
| Example | 26 | (Ca_{0.7}Sr_{0.3})(Zr_{0.97}Ti_{0.03})O₃ | Ni | Mn | 50.9 | 49.1 |
| Example | 27 | (Ca_{0.7}Sr_{0.3})(Zr_{0.97}Ti_{0.03})O₃ | Ni | Mn | 49.0 | 51.0 |
| Example | 28 | (Ca_{0.7}Sr_{0.3})(Zr_{0.97}Ti_{0.03})O₃ | Ni | Mn | 49.6 | 50.4 |
| Comparative | 29 | (Ca_{0.7}Sr_{0.3})(Zr_{0.97}Ti_{0.03})O₃ | Ni | — | — | — |
| Example | | | | | | |

| | | | | Third Subcomponent | | |
|---|---|---|---|---|---|---|
| Example/ | | | | Distribution | Distribution | |
| Comparative | Sample | Second | Third | Ratio to the | Ratio to the | MTTF |
| Example | No. | Subcomponent | Subcomponent | A-site [%] | B-site [%] | (h) |
| Example | 1 | Al, Si | Not Added | — | — | 1.42.E+03 |
| Example | 20 | Al, Si | V | 10.2 | 89.8 | 1.43.E+03 |
| Example | 21 | Al, Si | Ta | 10.2 | 89.8 | 1.59.E+03 |
| Example | 22 | Al, Si | Nb | 10.2 | 89.8 | 1.59.E+03 |
| Example | 23 | Al, Si | W, Ta | 10.4 | 89.6 | 1.60.E+03 |
| Example | 24 | Al, Si | W, Nb | 10.4 | 89.6 | 1.62.E+03 |
| Example | 25 | Al, Si | W | 10.5 | 89.5 | 1.65.E+03 |
| Example | 26 | Al, Si | (Mo) | 10.2 | 89.8 | 1.34.E+02 |
| Example | 27 | Al, Si | (Y) | 10.2 | 89.8 | 1.32.E+02 |
| Example | 28 | Al, Si | (Dy) | 10.0 | 90.0 | 1.02.E+02 |
| Comparative | 29 | Al, Si | W | 10.1 | 89.9 | 1.63.E+02 |
| Example | | | | | | |

As shown in Table 3, when the third subcomponent element Z3 (V, Nb, Ta, and/or W) is included, the samples satisfying the predetermined configuration exhibit extended service life in the high-temperature environment.

### Experimental Example 4 (Sample Nos. 31 to 33)

The capacitor samples of Sample Nos. 31 to 33 were prepared in the same manner as Sample No. 25 except for the following modification. The amounts of the dispersion of the third subcomponent element Z3 to be added to the first dispersion and the second dispersion were adjusted so that the distribution ratio of W to the B-site as the third subcomponent element was adjusted. These samples were evaluated in the same manner as Sample No. 25. Results are shown in Table 4.

TABLE 4

| | | | | | First Subcomponent | |
|---|---|---|---|---|---|---|
| Example/ | | | Electrode | | Distribution | Distribution |
| Comparative | Sample | | Main | First | Ratio to the | Ratio to the |
| Example | No. | Dielectric Main Composition | Composition | Subcomponent | A-site [%] | B-site [%] |
| Example | 31 | (Ca_{0.7}Sr_{0.3})(Zr_{0.97}Ti_{0.03})O₃ | Ni | Mn | 49.8 | 50.2 |
| Example | 32 | (Ca_{0.7}Sr_{0.3})(Zr_{0.97}Ti_{0.03})O₃ | Ni | Mn | 50.1 | 49.9 |
| Example | 25 | (Ca_{0.7}Sr_{0.3})(Zr_{0.97}Ti_{0.03})O₃ | Ni | Mn | 49.5 | 50.5 |
| Example | 33 | (Ca_{0.7}Sr_{0.3})(Zr_{0.97}Ti_{0.03})O₃ | Ni | Mn | 50.0 | 50.0 |

| | | | | Third Subcomponent | | |
|---|---|---|---|---|---|---|
| Example/ | | | | Distribution | Distribution | |
| Comparative | Sample | Second | Third | Ratio to the | Ratio to the | MTTF |
| Example | No. | Subcomponent | Subcomponent | A-site [%] | B-site [%] | (h) |
| Example | 31 | Al, Si | W | 30.2 | 69.8 | 2.98.E+02 |
| Example | 32 | Al, Si | W | 20.1 | 79.9 | 1.59.E+03 |
| Example | 25 | Al, Si | W | 10.3 | 89.7 | 1.65.E+03 |
| Example | 33 | Al, Si | W | 0 | 100 | 1.55.E+03 |

As shown in Table 4, the distribution ratio of the third subcomponent element to the B-site is preferably 70% or more, more preferably 80% or more.

### REFERENCE SIGNS LIST

1 . . . multilayer ceramic capacitor
2 . . . dielectric layer (insulating layer)
3 . . . internal electrode layer
4 . . . external electrode
10 . . . element body
14 . . . main phase grain
16 . . . grain boundary

What is claimed is:

1. A dielectric ceramic composition comprising:
a main component including a perovskite-type compound; and
a subcomponent,
wherein an A-site of the perovskite-type compound includes at least Ca,
a B-site of the perovskite-type compound includes at least Zr,
the subcomponent includes Mn as a first subcomponent element, and
the first subcomponent element is present at both the A-site and the B-site of the perovskite-type compound.

2. The dielectric ceramic composition according to claim 1, wherein a distribution ratio of the first subcomponent element to the B-site, which is a ratio of the number of atoms of the first subcomponent element present at the B-site to the total number of atoms of the first subcomponent element present at the A-site and the B-site of the perovskite-type compound, is 20 to 80%.

3. The dielectric ceramic composition according to claim 1, wherein the subcomponent further includes a second subcomponent element comprising at least one selected from the group consisting of Mg, Al, Si, Li, B, and P.

4. The dielectric ceramic composition according to claim 1, wherein the subcomponent further includes a third subcomponent element comprising at least one selected from the group consisting of V, Nb, Ta, and W.

5. The dielectric ceramic composition according to claim 4, wherein the third subcomponent element is present at least at the B-site of the perovskite-type compound, and
a distribution ratio of the third subcomponent element to the B-site, which is a ratio of the number of atoms of the third subcomponent element present at the B-site to the total number of atoms of the third subcomponent element present at the A-site and the B-site of the perovskite-type compound is 70% or more.

6. The dielectric ceramic composition according to claim 1, wherein the A-site of the perovskite-type compound further contains at least Sr, and the B-site of the perovskite-type compound further contains at least Ti.

7. The dielectric ceramic composition according to claim 1, wherein the main component of the perovskite-type compound is represented by the following formula: 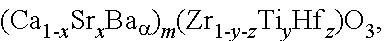
in which the following conditions are satisfied: 0.9≤m≤1.1, 0≤x≤1, 0.80≤1-y-z≤1.0, and α<1.

8. The dielectric ceramic composition according to claim 7, wherein y is greater than 0 and not more than 0.1.

9. A multilayer ceramic electronic device comprising the dielectric ceramic composition according to claim 1.
